(19) United States
(12) Patent Application Publication
(10) Pub. No.: US 2017/0172193 A1
(43) Pub. Date: Jun. 22, 2017

(54) SALAD MAKING DEVICE

(71) Applicant: Lucas J. Myslinski, Sunnyvale, CA (US)

(72) Inventor: Lucas J. Myslinski, Sunnyvale, CA (US)

(21) Appl. No.: 15/342,625

(22) Filed: Nov. 3, 2016

Related U.S. Application Data
(60) Provisional application No. 62/270,440, filed on Dec. 21, 2015.

(51) Int. Cl. A23L 27/60; A23P 10/25; A23L 29/212

(52) U.S. Cl. CPC A23L 27/60; A23L 29/212; A23P 10/25; A23V 2002/00

(57) ABSTRACT

A salad making device is able to be used to make a handheld salad for easier consumption instead of the typical salad in a bowl. A wrapper is able to be used to secure the compacted salad materials.

### CROSS-REFERENCE TO RELATED APPLICATION(S)

This application claims the benefit of U.S. Provisional Patent Application Ser. No. 62/270,440, filed Dec. 21, 2015, and titled “SALAD MAKING DEVICE,” which is hereby incorporated by reference in its entirety for all purposes.

### FIELD OF THE INVENTION

The present invention relates to the field of salad preparation.

### BACKGROUND OF THE INVENTION

Typically, salad is made by chopping lettuce and other vegetables and placing them in a bowl to be eaten with a fork. This has several significant drawbacks.

### SUMMARY OF THE INVENTION

The salad making device is able to be used to make a handheld salad for easier consumption instead of the typical salad in a bowl.

### BRIEF DESCRIPTION OF THE DRAWINGS

FIG. 1 illustrates a side view of a manual implementation of a tubular salad making device according to some embodiments.

FIG. 2 illustrates a side view of a manual implementation of a tubular salad making device according to some embodiments.

FIG. 3 illustrates a side view of a manual implementation of a double-ended salad making device according to some embodiments.

FIG. 4 illustrates a side view of a manual implementation of a double-ended salad making device with a top aperture according to some embodiments.

FIG. 5 illustrates a side view of a manual implementation of an open top salad making device according to some embodiments.

FIG. 6 illustrates a side view of a handheld compressible salad making device according to some embodiments.

FIG. 7 illustrates a side view of the two halves of the compressible salad making device according to some embodiments.

FIG. 8 illustrates a top view of the two halves of the compressible salad making device according to some embodiments.

FIG. 9 illustrates a top view of the two halves of the compressible salad making device with a band or sleeve holding the two halves together according to some embodiments.

FIG. 10 illustrates a side view of a lever salad making device according to some embodiments.

FIG. 11 illustrates views of clamshell salad making devices according to some embodiments.

FIG. 12 illustrates views of a curved salad making device according to some embodiments.

FIG. 13 illustrates a view of a handheld salad making device with a wrapper according to some embodiments.

FIG. 14 illustrates a view of an open-ended handheld salad making device with a wrapper according to some embodiments.

FIG. 15 illustrates a view of an open-ended handheld salad making device with a cone-shaped wrapper according to some embodiments.

FIG. 16 illustrates a view of a cone-shaped handheld salad making device with a cone-shaped wrapper according to some embodiments.

FIG. 17 illustrates a view of a tube-shaped handheld salad making device with a narrowed end according to some embodiments.

FIG. 18 illustrates a view of salad making devices making compact salads according to some embodiments.

FIG. 19 illustrates a powered salad making device according to some embodiments.

FIG. 20 illustrates a cross-sectional view of the powered salad making device according to some embodiments.

FIG. 21 illustrates a cross-sectional view of the powered salad making device according to some embodiments.

FIG. 22 illustrates a cross-sectional view of the powered salad making device according to some embodiments.

FIG. 23 illustrates a cross-sectional view of the powered salad making device according to some embodiments.

FIG. 24 illustrates a cross-sectional view of the powered salad making device according to some embodiments.

FIG. 25 illustrates a cross-sectional view of the powered salad making device according to some embodiments.

FIG. 26 illustrates vacuum-seal salad making devices according to some embodiments.

FIGS. 27 and 28 show different shapes of wrappers according to some embodiments.

FIG. 29 illustrates a flowchart of a salad compacting method according to some embodiments.

FIG. 30 illustrates a block diagram of an exemplary computing device configured to implement the salad making method according to some embodiments.

FIG. 31 illustrates a network of devices configured to implement salad making according to some embodiments.

FIG. 32 illustrates a flowchart of a method of generating a wrapper according to some embodiments.

FIG. 33 illustrates diagrams of salad dressing strips, balls, chunks, crystals, and shreds according to some embodiments.

FIG. 34 illustrates a diagram of a salad dressing material portable container according to some embodiments.

FIG. 35 illustrates a diagram of a wrapper with multiple layers according to some embodiments.

FIG. 36 illustrates a view of a handheld salad making device with a wrapper holder and a wrapper according to some embodiments.

### DETAILED DESCRIPTION OF THE PREFERRED EMBODIMENT

A salad making device enables a user to make a handheld salad. The salad making device is able to be implemented in a variety of different embodiments to make a handheld salad. The salad making device is able to be implemented using manual (e.g., hand press) or motor compression or another type of compression. The salad making device is able to be implemented with or without a salad wrapper. The salad materials are able to be pushed into a wrapper. The wrapper is able to be any shape and composed of any material.

In some embodiments, the wrapper is made of an edible material such as solidified salad dressing, salad dressing-flavored rice paper, salad dressing-flavored milk paper, salad dressing-flavored starch, and/or any other flavored or non-flavored material. In some embodiments, the wrapper is made such that it can receive the salad materials but dissolves in a user's mouth. In some embodiments, the wrapper is stronger such that it is chewed to be eaten. In some embodiments, the wrapper is able to be vacuum-shrunk onto the salad materials.

The salad making device is able to include additional components such as a washer, a shredder, a grinder, a chopper, a mixer, and/or any other component. The salad making device is able to include computing and networking capabilities as well. The handheld salad is able to be formed in any form such as substantially flat, substantially cubical, substantially spherical, substantially rectangular cubical, substantially conical, substantially pyramidal, substantially cylindrical, and/or any other shape.

The salad making device is able to be any shape. In some embodiments, the salad making device is mostly rectangular cubical, cubical, spherical, conical, and/or any other shape. Although some embodiments might be shown as one shape, it is understood that they could be any other shape. For example, a figure may show a rounded tube, but the embodiment could also be a rectangular tube or another shape.

In some embodiments, the salad making device is able to convert into a dish. For example, after the salad making device is used to compact the salad materials into a compact salad, the salad making device is able to be flattened to be used as a dish by using hinges which enable the walls of the salad making device to collapse and flatten.

In some embodiments, there is a home version and a portable version of the salad making device where the portable version is more compact than the home version.

The salad making device is easily cleanable.

The salad making device and any components of the salad making device are able to be made of any material such as metal, plastic, silicone, wood, ceramic, melamine, rubber, non-stick material (e.g., Teflon®) and/or any combination thereof

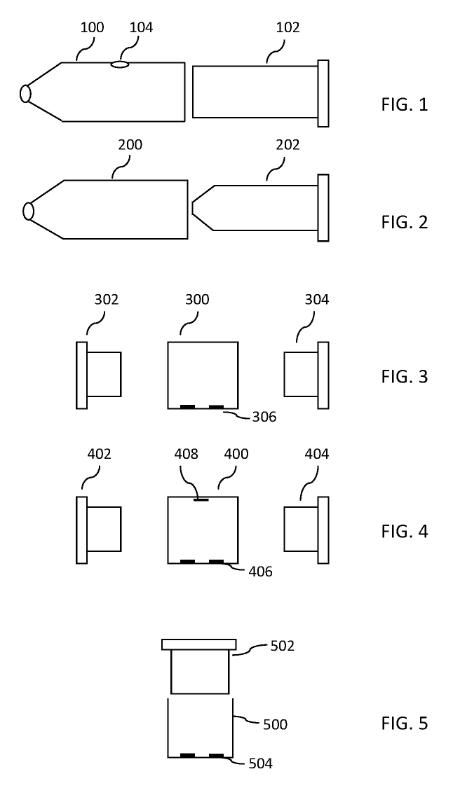

FIG. 1 illustrates a side view of a manual implementation of a tubular salad making device according to some embodiments. A first component 100 is a round cylinder with a narrowing end including a first aperture and a non-narrowing end with a second aperture (e.g., the second aperture is larger than the first aperture). A second component 102 is configured to fit within the first component 100 through the second aperture. For example, a user places salad materials (e.g., lettuce, any other vegetables, any meats, any fruits, any nuts, any cheeses, any salad dressing, any noodles, and/or any other materials to make a salad) in the first component 100 via the second aperture. The user then inserts the second component 102 into the second aperture of the first component 100. As the user pushes the second component 102 further into the first component 100, the second component 102 pushes the salad materials through the first aperture which is relatively small (e.g., 1 inch diameter) compared to the second aperture (e.g., 3 inch diameter). Since the first aperture is small, the salad materials are compressed within the first component 100 while they are pushed through the first aperture. In some embodiments, the first component 100 (or any components described herein) includes one or more holes to enable excess water (e.g., from the lettuce or other salad materials) to drain to prevent an overly watery compacted salad. In some embodiments, the first component 100 includes a hole 104 in the top to enable a user to input flavored crystals/sprinkles, salad dressing and/or any other substance/materials.

FIG. 2 illustrates a side view of a manual implementation of a tubular salad making device according to some embodiments. The salad making device of FIG. 2 is similar to the salad making device of FIG. 1 with the exception that the first end of the second component 202 of the salad making device of FIG. 2 narrows (e.g. goes from 3 inches in diameter to 1 inch in diameter gradually), whereas the first end of the second component 102 of the salad making device of FIG. 1 is flat. The first component 200 of the device of FIG. 2 is similar to the first component 100 of the device of FIG. 1.

FIG. 3 illustrates a side view of a manual implementation of a double-ended salad making device according to some embodiments. A central component 300 includes two side apertures configured for receiving a left component 302 and a right component 304. Salad materials are input into the central component 300 through either of the side apertures or through a panel which is able to open (e.g., using hinges 306). After the salad materials are input, the left and right components 302, 304 are inserted into the apertures and compress the salad materials into a handheld salad. The handheld salad is able to be removed from the device from either of the apertures or the panel. The device is able to have any number of panels (e.g., side, top, bottom) which are able to open in any manner.

FIG. 4 illustrates a side view of a manual implementation of a double-ended salad making device with a top aperture according to some embodiments. A central component 400 includes two side apertures configured for receiving a left component 402 and a right component 404. The device of FIG. 4 is similar to the device of FIG. 3 except that it also includes a top aperture 408 configured for receiving salad dressing and/or salad materials. Salad materials are input into the central component 400 through either of the side apertures or through a panel which is able to open (e.g., using hinges 406).

FIG. 5 illustrates a side view of a manual implementation of an open top salad making device according to some embodiments. The first component 500 is a cube or rectangular cube with an open top side. The second component 502 is configured to fit within the open top side to compress the salad materials within the first component 500 (e.g., by a user pushing down on the end of the second component). After the salad materials are compressed into a handheld salad, the handheld salad is able to be removed from the open top side or by opening a panel of the first component (e.g., using hinges 504).

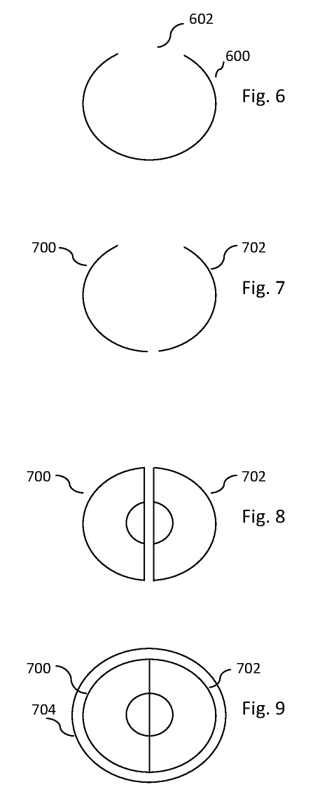

FIG. 6 illustrates a side view of a handheld compressible salad making device according to some embodiments. The compressible salad making device 600 is made of a material such as soft plastic or silicone which is easily squeezable within one's hand (e.g., an average adult's hand). The compressible salad making device 600 is roughly spherical in shape including an aperture 602 sized to be able to receive salad materials. The salad materials are inserted into the compressible salad making device 600, and then the user squeezes the compressible salad making device to compress the salad materials into a handheld salad. In some embodiments, the compressible salad making device 600 includes two components (e.g., halves which are able to couple together by friction or a securing mechanism such as a band which holds the two components together temporarily). In some embodiments, a wrapper shaped similar to the compressible salad making device 600 is able to be inserted into the compressible salad making device 600 to receive and secure the salad materials.

FIG. 7 illustrates a side view of the two halves of the compressible salad making device according to some embodiments. The first side 700 and the second side 702 (e.g., halves) are able to couple together by friction or a securing mechanism.

FIG. 8 illustrates a top view of the two halves of the compressible salad making device according to some embodiments. As shown the first side 700 and the second side 702 have a half circle aperture at the top for receiving the salad materials. In some embodiments, there is no aperture, and the salad materials are placed inside one of the halves.

FIG. 9 illustrates a top view of the two halves of the compressible salad making device with a band 704 or sleeve holding the two halves 700, 702 together according to some embodiments.

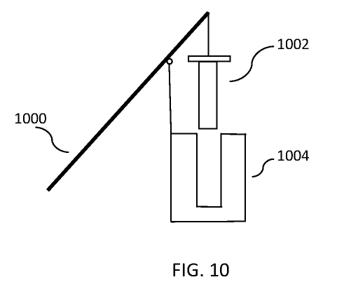

FIG. 10 illustrates a side view of a lever salad making device according to some embodiments. When a handle 1000 of the lever is pushed up or down, depending on the implementation, the opposing end (e.g., with a solid component 1002) goes into a receiving component 1004, and when salad materials are in the receiving component, the solid component 1002 pushes or compacts the salad materials into a compacted form. In some embodiments, the lever salad making device includes multiple levers. The levers are able to be configured in any manner to compress the salad materials.

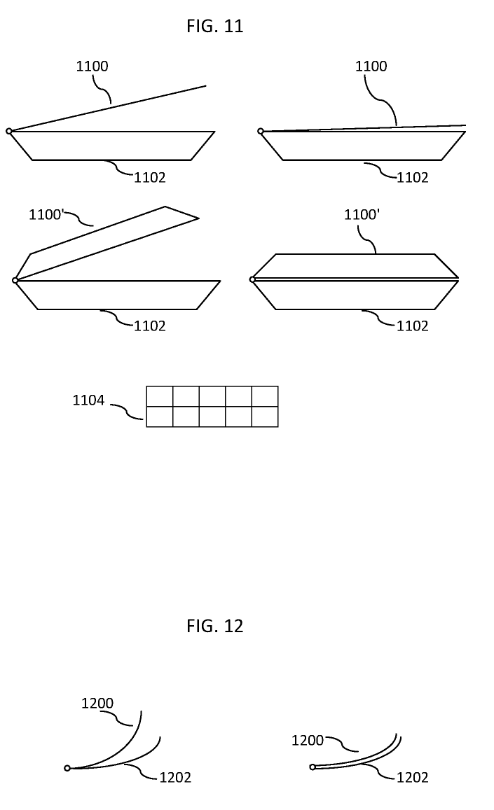

FIG. 11 illustrates views of clamshell salad making devices according to some embodiments. For example, a flat top clam shell implementation has a flat top 1100 which closes on a container portion 1102, thereby compacting any salad materials within the container. The flat top 1100 and the container portion 1102 are able to be coupled in any manner such as by a hinge. In some embodiments, the top portion 1100′ is not flat and is shaped similarly to the container portion 1102. In some embodiments, the top portion 1100′ and/or the container portion 1102 includes sections similar to an ice cube tray 1104 to make separate salads. In some embodiments, the top portion 1100 is shaped or has an inner portion which fits within the container portion to further compact the salad materials.

FIG. 12 illustrates views of a curved salad making device according to some embodiments. The top component 1200 and the bottom component 1202 are each curved with the same curvature or a different curvature. The components 1200, 1202 are coupled using any coupling such as a hinge. The top component 1200 and bottom component 1202 are brought together to compact any salad materials between the components.

FIG. 13 illustrates a view of a handheld salad making device with a wrapper according to some embodiments. The handheld salad making device includes a plunger portion 1300 or insertable portion (e.g., a solid tube with a cap) and a receiving portion 1302 (e.g., a hollow tube). In some embodiments, the hollow tube has a bottom cap/end which is able to be locked (while the salad materials are being compacted) and opened (for removal of the compacted salad). The wrapper 1304 is able to be made of any materials as described herein such as solidified salad dressing. The wrapper 1304 (e.g., a cube with an open side or a 5 sided cube) is inserted into the receiving portion 1302, and then salad materials are inserted into the receiving portion 1302. Then, the plunger portion 1300 is inserted into the receiving portion 1302 which compacts the salad materials into the wrapper 1304. In some embodiments, the bottom of the receiving portion 1302 is unlocked and opened, and then the wrapper 1304 containing the compacted salad is removed. In some embodiments, the receiving portion 1302 includes a wrapper holder implementation 1306 (e.g., a tab, indentation, bump, groove, notch, lip) to secure the wrapper in place while the salad materials are compacted within the wrapper.

FIG. 14 illustrates a view of an open-ended handheld salad making device with a wrapper according to some embodiments. The open-ended device of FIG. 14 is similar to the device of FIG. 13, except the receiving portion 1402 or component is open ended so that the wrapper 1404 is able to be inserted into the receiving portion 1402 at either end, and then after the salad material is inserted and compacted, the wrapper 1404 containing the salad is output from the opposite end of where the plunger portion 1400 is pushing from. In some embodiments, a user places his/her hand over an opening to prevent the salad materials from leaving the receiving portion 1402 until the salad materials are compacted.

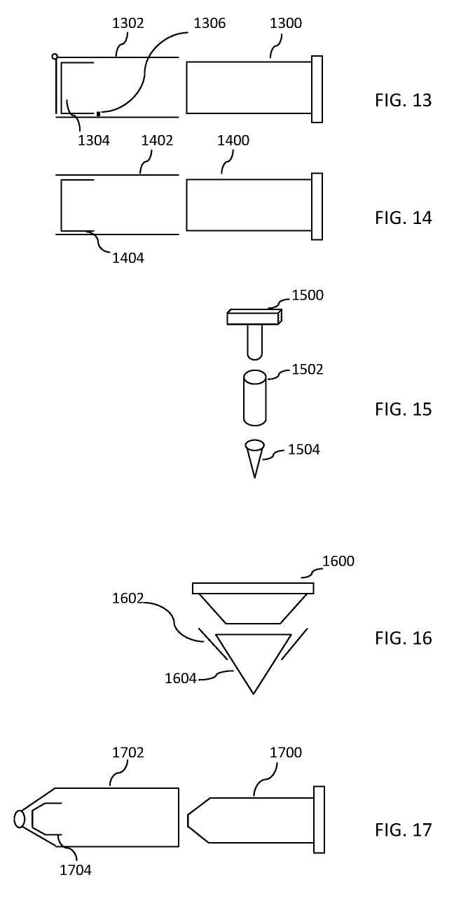

FIG. 15 illustrates a view of an open-ended handheld salad making device with a cone-shaped wrapper according to some embodiments. The device of FIG. 15 is similar to the device of FIG. 14. The cone-shaped wrapper 1504 is sized so that it will fit within the receiving portion 1502, but also large enough so that there will be some friction containing the cone-shaped wrapper 1504 within the receiving portion 1502. For example, the larger end or open end of the cone-shaped wrapper 1504 is 10% larger than the inside of the receiving portion 1502. In other words, the wrapper 1504 has diameter that is 10% larger than the diameter of the opening of the receiving portion 1502. Any size is possible, e.g. the wrapper is able to be smaller, same size, 10% larger, 25% larger, 50% larger, 100% larger or more, than the opening or inner open area of the receiving portion 1502. The plunger portion 1500 pushes salad materials in the receiving portion 1502 into the wrapper 1504.

FIG. 16 illustrates a view of a cone-shaped handheld salad making device with a cone-shaped wrapper according to some embodiments. The receiving portion 1602 of the cone-shaped handheld salad making device is an open-ended cone, open on the top and bottom, and the plunger portion 1600 is shaped to fit within the receiving portion 1602 such that when the plunger portion 1600 is placed within the receiving portion 1602, any salad materials within the receiving portion 1602 are compacted and pushed into the cone-shaped wrapper 1604 contained within the receiving portion 1602 and out of the receiving portion 1602 as a compacted salad with a wrapper 1604.

FIG. 17 illustrates a view of a tube-shaped handheld salad making device with a narrowed end according to some embodiments. The receiving portion 1702 of the tube-shaped handheld salad making device receives the wrapper 1704, the salad materials and the plunger portion 1700. The narrowed end is narrower than the majority of the tube (e.g., 75%, 90%, 95%, or another amount), such that when the plunger portion 1700 pushes the salad and the wrapper 1704, they are extruded out of an opening of the narrowed end as a compacted salad due to the pressure of the plunger portion 1700 and the shape of the receiving portion 1702.

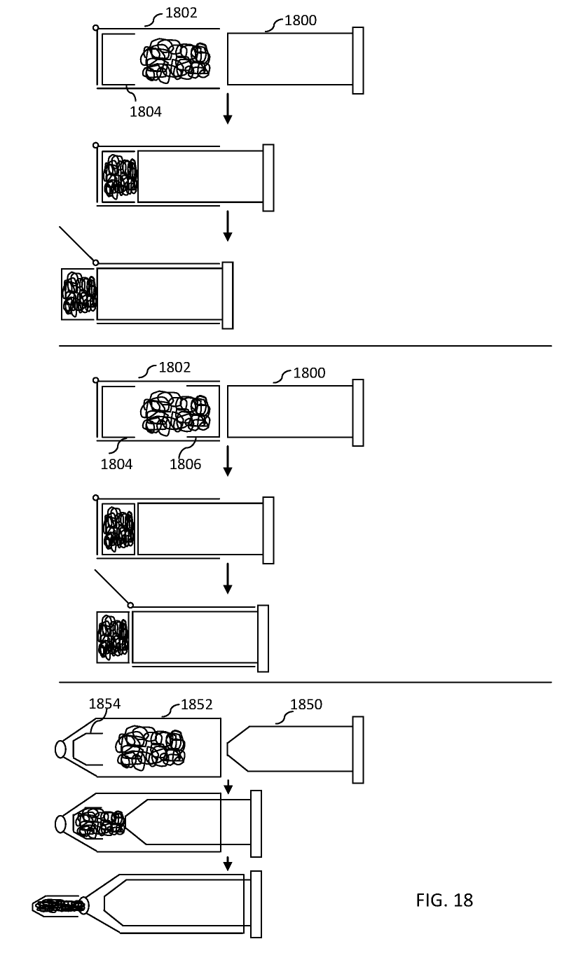

FIG. 18 illustrates a view of salad making devices making compact salads according to some embodiments. As shown in the figures, after a user places the wrapper and the salad materials within the receiving component 1802, the plunging component 1800 compacts the salad materials into the wrapper 1804, and then the compacted salad (in the wrapper) is output from the receiving component 1802 (e.g., by opening a hinged back door or through an extrusion hole). In the middle figure, two wrappers are utilized to secure the compacted salad materials.

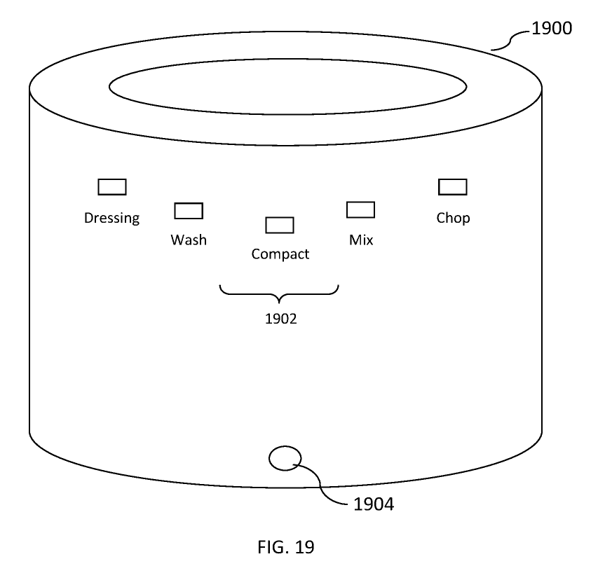

FIG. 19 illustrates a powered salad making device according to some embodiments. The powered salad making device 1900 includes a body (any shape or size), for example, hollow, cylindrical shape with a bottom and an open top. The internal components of the powered salad making device 1900 are able to be any components to perform the salad making process. In some embodiments, the internal components include a rotatable plate which spins (e.g., a motor is coupled to a rod coupled to a plate, and when the motor is triggered, the rod and plate spin). In some embodiments, one or more motors are implemented to control the internal components. In some embodiments, the internal components include one or more water sprayers to wash the salad materials, and apertures on the bottom of an internal bowl/holding area, and a collection plate, so that the dirty water is able to leave the holding area and go into the collection plate. In some embodiments, the internal components include one or more dressing sprayers/drippers for applying salad dressing. In some embodiments, the internal components include a compacting area configured for compacting the salad materials. In some embodiments, the internal components include an internal chamber with movable sides which are able to close together to compact the salad. In some embodiments, the internal components include tubing which receives the salad materials, and by using forced air or a plunger, the salad materials are pushed through the tubing which compacts the salad materials. In some embodiments, after being compacted, the salad materials are output through an aperture 1904.

In some embodiments, the salad making device includes a removable or a nonremovable bowl/container which fits within the body of the salad making device.

In some embodiments, the salad making device includes multiple levels or compartments for each step. For example, a first compartment is where the salad is washed, a second compartment is where the salad is chopped, a third compartment is where the salad is mixed, a fourth compartment is where the salad dressing is applied and a fifth compartment is where the salad is compacted. In some embodiments, the compartments are vertically configured (e.g., one on top of the other). In some embodiments, one or more of the compartments is for more than one action (e.g., same compartment is for washing and mixing the salad materials).

In some embodiments, the powered salad making device also includes a display, buttons 1902 and/or any other user interface. For example, the powered salad making device includes a wash button, a compact button, a chop button, a dressing button and a mix button and the corresponding electronic circuitry. The user places the salad materials in the open chamber of the powered salad making device.

When the user presses the mix button, the salad materials are mixed. For example, a mixing arm turns and mixes the salad materials together. In some embodiments, mixing and/or washing is implemented by vibrations or a back and forth spinning motion.

When the user presses the chop button, the salad materials are chopped using internal blades or any other chopping mechanism.

When the user presses the wash button, the salad materials are washed. For example, the internal spray component, sprays the salad materials with water. In some embodiments, the salad materials are also moved around while being sprayed using a rotating motion. In some embodiments, after the salad materials are washed, they are also sprayed with a salad dressing using the same or different spray components.

When the user presses the dressing button, salad dressing is applied to the salad materials. The salad dressing is sprayed using the same spray components as used for washing the salad materials or a second set of spray components or another implementation.

When the user presses the compact button, the salad materials are compacted.

The powered salad making device includes a power source such as a battery, a power cord, and/or a solar panel. In some embodiments, the powered salad making device includes computing components (e.g., a standard computer including a processor, a memory, software, and any other computing components). In some embodiments, the powered salad making device includes wireless/networking capabilities (e.g., a user is able to control the salad making device using their her smart phone). In some embodiments, one or more of the components are detachable (e.g., a mixer insert is able to be removed).

In some embodiments, the powered salad making device includes a wrapper receiving component for receiving and/or storing one or more wrappers.

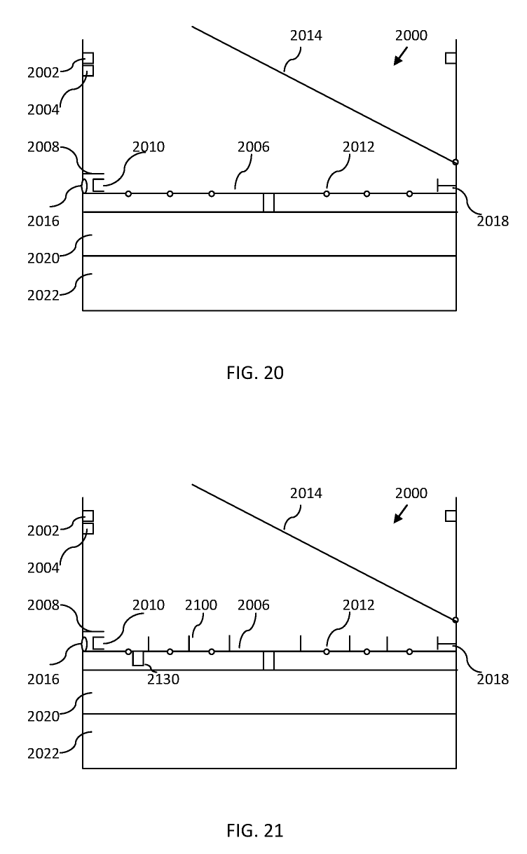

FIG. 20 illustrates a cross-sectional view of the powered salad making device according to some embodiments. The device 2000 includes a lid 2014 which opens and closes so that a user can place the salad materials in the device 2000 and close the lid 2014 to secure the salad materials in place on the plate/floor 2006. In some embodiments, the lid 2014 is lockable in place. In some embodiments, the plate/floor 2006 has holes 2012 for the water to drain. The plate 2006 is rotatable using a motor 2020, where the rotation is able to be used to spin the salad materials dry (e.g., after washing) or to mix the salad materials. The device 2000 includes a motor 2020 to rotate the plate 2006. The motor 2020 is also used to move a compacting wall 2018. After the lid 2014 is closed, the salad materials are sandwiched between the lid 2014 and the plate/floor 2006, so when the compacting wall 2018 pushes from the right to left or vice versa, the salad materials are compacted since they have no place to go other than a smaller and smaller place, eventually being compacted into a wrapper 2010. The device 2000 includes a wrapper holder 2008 for securing a wrapper 2010, and an extrusion hole 2016 to enable the compacted salad to exit the device 2000. In some embodiments, the compacting wall 2018 utilizes a telescoping arm to extend from one side to another. The device 2000 includes one or more sprayers 2002 for spraying water to wash the salad materials, and one or more sprayers 2004 for spraying salad dressing on the salad materials. In some embodiments, the device 2000 includes a water reservoir for storing water to spray, and a salad dressing reservoir for storing salad dressing to spray. In some embodiments, the device 2000 includes computer components 2022 including a wireless communication implementation so that the device is able to communicate wirelessly (e.g., with a user's smart phone). The device 2000 is able to have fewer or additional components.

FIG. 21 illustrates a cross-sectional view of the powered salad making device according to some embodiments. FIG. 21 is similar to FIG. 20, except FIG. 21 includes retractable or non-retractable blades 2100 for chopping the salad materials. For example, the retractable blades 2100 extend outward, and by using rotation of the plate 2006 or an up and down motion of the plate 2006, the blades 2100 chop the salad materials. FIG. 21 also shows a sensor 2130 which is capable of determining how much salad materials have been compressed (e.g., by determining how much water has been released by the salad materials—for example, stop compacting the salad materials once 1 ml of water is detected).

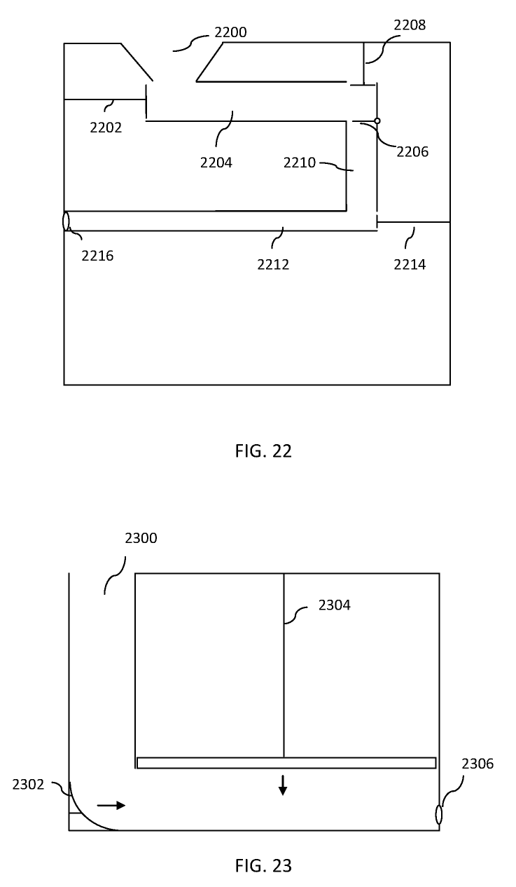

FIG. 22 illustrates a cross-sectional view of the powered salad making device according to some embodiments. A funnel-shaped opening 2200 receives the salad materials. A first plunger 2202 or compacting wall is used to push the salad materials through a first tube 2204 (any shaped tube). A trap door 2206 opens at the end of the first tube 2204 after the salad materials are compacted in the first tube 2204. A second plunger 2208 pushes the salad materials that do not fall due to gravity through a second tube 2210 and compacts the salad further. In some embodiments, there is no second plunger, and only gravity is used to allow the salad materials to fall. In some embodiments, the second tube 2210 is smaller (e.g., narrower) than the first tube 2204. A third plunger 2214 pushes the salad materials through a third tube 2212. In some embodiments, the third tube 2212 is smaller (e.g., narrower) than the second and first tubes. The third plunger 2214 pushes the salad materials to compact them even further until they are output from the device in a compacted form through an aperture 2216. In some embodiments, a wrapper is utilized. In some embodiments, fewer or additional tubes are used. In some embodiments, the tubes go in the same direction (e.g., all horizontal, all vertical), and in some embodiments, the tubes go in different directions (e.g., horizontal and vertical). The device includes a motor (or multiple motors) and/or any other components to utilize the device. In some embodiments, the wrapper is placed in the device at the top and the salad materials are compacted into the wrapper in multiple tubes.

FIG. 23 illustrates a cross-sectional view of the powered salad making device according to some embodiments. A side chute 2300 allows a user to place the salad materials in the device, and a curved ramp 2302 guides the salad materials under a plunger 2304 which compacts the salad materials by moving downward. In some embodiments, the curved ramp 2302 is also a plunger which moves to the side to further compact the salad materials. A side door/aperture 2306 is able to be opened to remove the compacted salad or allow the compacted salad to be pushed out of the device.

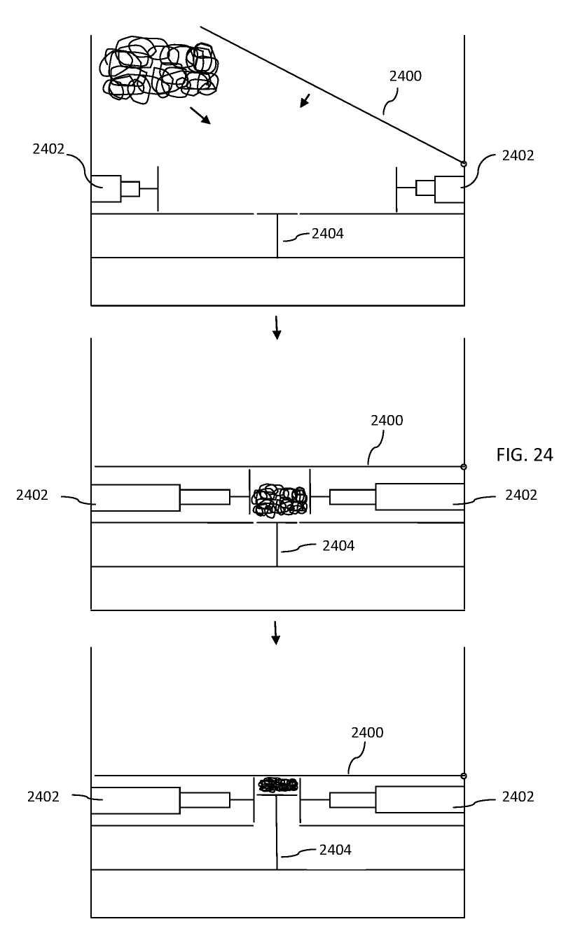

FIG. 24 illustrates a cross-sectional view of the powered salad making device according to some embodiments. A lid/cover 2400 is opened, and salad is placed in the salad making device. The lid 2400 closes on the salad such that the salad is in a confined space. In some embodiments, the lid 2400 locks into place. Two telescoping side plungers/compactors 2402 compact the salad inward, as shown in the middle picture. An upward plunger/compactor 2404 (telescoping or not) compact the salad upward. As shown in the bottom picture, the salad is compacted into a compacted salad.

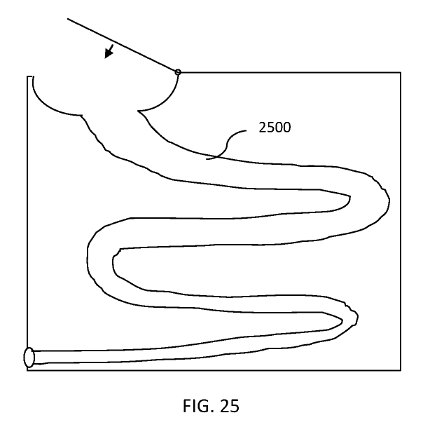

FIG. 25 illustrates a cross-sectional view of the powered salad making device according to some embodiments. Using a tube 2500 that gradually becomes smaller and compressed air (e.g., a motor blows air in the tube) or another mechanism to move the salad materials through the tube, the powered salad making device is able to compact the salad materials into a cylindrical compacted salad.

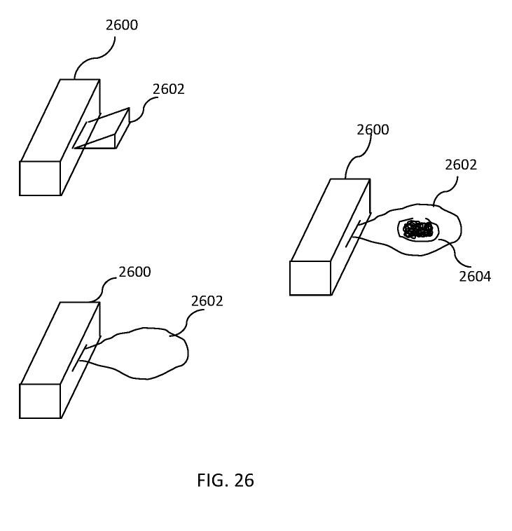

FIG. 26 illustrates vacuum-seal salad making devices according to some embodiments. Salad materials are placed in a wrapper 2602, and the wrapper is inserted into the vacuum sealing device 2600 which removes most or all of the air out of the wrapper 2602 which compresses the wrapper 2602 on the salad materials resulting in a compact salad. In some embodiments, where the wrapper 2602 may not be air tight (e.g., non-vacuum sealable), a covering wrapper may be used for compression. For example, salad materials are placed in an edible, but non-air tight wrapper 2604. Then, the edible wrapper 2604 is placed in the vacuum-sealable wrapper 2602 which compresses the edible wrapper 2604 and the salad materials. The vacuum sealable wrapper 2602 is then removed, leaving the edible wrapper 2604 and the salad materials as a compacted salad.

As described herein, the salad materials and/or wrappers are able to be compacted in any manner using any implementation such as compacting with moving walls, arms, levers, clam-shell features, tubing, narrowing/shrinking of areas such as narrowing tubing, smaller compacting spaces, vacuum-sealing, freezing, heating, motorized compacting, manual compacting, and/or a combination thereof

Any of the salad making devices described herein are able to be implemented with or without a salad wrapper.

In some embodiments, the salad is compacted so that it is 1%-50% of the original salad by volume in a compacted form. For example, if uncompacted salad materials are 100% volume, the salad materials are compacted so that they are only 1% of the 100% volume or 50% of the 100% volume (e.g., half the size) or somewhere in between. In some embodiments, a user is able to control the compactedness, e.g., button (or other input implementation) on a machine enables a user to specify 1%, 5%, 10%, 25% volume. For example, a user inputs 25% on his smart phone, which sends the input to the device which then compacts the salad so that it is ¼ the size of the original volume. Other inputs schemes are able to be used instead of percent, such as inches/centimeters (e.g., a 1×1×1 in cube). In some embodiments, additional salad preparation/making features are included such as washing, chopping, dressing, spinning/drying, mixing, and/or any other salad preparation/making features. In some embodiments, storage components are included with the salad making device to store/receive additional materials such as bacon bits, salad dressing, wrappers, croutons and/or their containers.

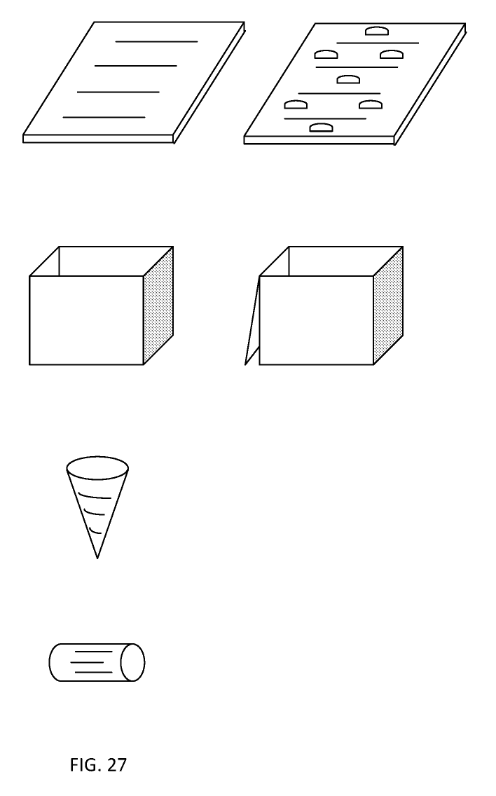

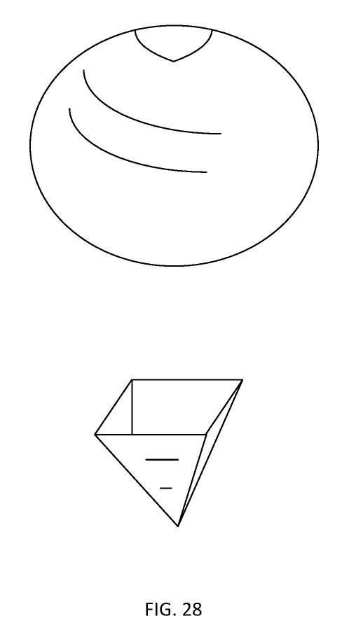

FIGS. 27 and 28 show different shapes of wrappers according to some embodiments. As described herein, the wrappers are able to be any shape or size such as a flat piece, an open box/cube(e.g., a cube with 5 sides), a cone, or a cylinder as shown in FIG. 27. In some embodiments, the wrapper includes a flap/foldable portion to cover an opening (e.g., as shown in the second drawing of the open cube). The flap is able to be positioned over the opening after the salad materials compacted inside to ensure the salad materials do not fall out of the opening.

In some embodiments, the wrapper includes dots/bumps of flavoring such as a salad dressing flavoring (e.g., as shown in the second drawing of the flat piece). The dots/bumps are able to be placed on the wrapper in a random distribution or a uniform distribution. The dots/bumps are a flavoring solution which is able to dry and form solid dots/bumps which maintain their shape or disperse when wet. In some embodiments, the dots/bumps are raised dots/bumps (e.g., approximately half of a centimeter high although could be 1 mm (or less) to 1 cm high (or more)). FIG. 28 shows spherical wrapper with an opening and a pyramidal wrapper. The wrappers are able to be used to receive the salad materials and/or maintain the salad materials in a compact state. In some embodiments, the wrappers are colored so that users are able to distinguish their salad. The wrappers are able to be colored in any manner such as using natural food extracts (e.g., beet juice for red) or another food coloring mechanism. The wrappers are able to be pre-colored, or users are able to add coloring just before or while compacting the salad.

In some embodiments, the wrapper dissolves upon contacting water. In some embodiments, the wrapper does not dissolve upon contacting water. In some embodiments, the wrapper partially dissolves upon contacting water (e.g., the flavor layer dissolves but he structure/starch layer does not). The wrapper is able to be made out of any material. In some embodiments, the wrapper is edible, and in some embodiments, the wrapper is inedible. In some embodiments, the wrapper is a rice paper or film. In some embodiments, the wrapper is starch (e.g., corn, potato, tapioca) and/or a mixture. In some embodiments, the wrapper is flavored with an additional flavoring (e.g., a salad dressing flavoring), and in some embodiments, the wrapper is not flavored with an additional flavoring.

In some embodiments, the wrapper is made of a thin film or dissolving film using any thin film making technology. For example, the wrapper is made of egg whites and food fiber. In some embodiments, the wrapper is sprayed onto the compact salad, the salad is dipped into a liquid wrapper, or the wrapper is secured on the compact salad another way. In another example, the thin film is made of a starch and lecithin. The thin films are also able to include a flavoring such as salad dressing.

In some embodiments, the opposing sides of the wrapper are the same, and in some embodiments, they are different. For example, both sides are smooth/non-tacky/non-sticky or both sides are tacky/sticky. In another example, one side is sticky and the opposite side is non-sticky. The non-sticky side is able to be coated with oil, smoothed/flattened, coated with a powder/coating (e.g., flour). The sticky side is able to be sticky by using guar gum, xanthan gum, sugar, and/or any other material. In some embodiments, the side or sides are non-sticky when dry but become sticky when wet or vice versa. In some embodiments, the outer edge/rim of the wrapper is sticky, but the inner portion is not.

In some embodiments, the wrapper is made by baking, sun-drying, convection, dehydration, and/or any other method. For example, a starch is mixed with salad dressing materials, and then the mixture is placed in a 2-D or 3-D mold which is placed in a heating device (e.g., oven), which cooks the mixture until it solidifies.

The wrapper is able to be any 2-D shape such as a square, circle or triangle. The wrapper is able to be any 3-D shape (with an open/openable end) such as a cube, cone, pyramid, sphere, tube/cylinder or cup.

The wrapper is able to be used to make bite-sized or larger shapes such as squares and balls.

By using a wrapper, the salad materials are compacted in a confined place and are held together. Although some implementations are able to compact the salad materials without a wrapper, a wrapper provides a very secure hold of the salad materials. For example, some salad materials may fall apart without a wrapper, but the wrapper maintains structural integrity of the compacted salad materials. Furthering the example, if a user attempted to compact celery chunks, the celery chunks likely would not stay together in an easily held form; however, by compacting the celery chunks into a wrapper, the celery chunks will stay together within the wrapper, and thus will be much easier to eat and cause less of a mess.

In some embodiments, each wrapper includes an inedible portion and an edible portion. For example, the inedible portion is wax paper or a similar material. The wrapper including the inedible portion and the edible portion are able to be inserted into a salad making device such that the salad materials are compacted into the edible portion, and the inedible portion is removable by sliding the inedible portion off the edible portion after being compacted. The inedible portion is able to be used to help prevent the edible portion from sticking to the salad making device or getting dirty. The inedible portion is able to be shaped or sized similar to the wrapper described herein (e.g., 3D, slightly larger than a device aperture, and/or any other shape or size).

In some embodiments, the salad materials are placed in the wrapper before, during or after being compacted by the salad making device.

In some embodiments, multiple wrappers are used to secure the salad materials. For example, a first wrapper is inserted into a receiving portion of a salad making device, then the salad materials are placed in the receiving portion of the salad making device, and then a second wrapper is inserted into the receiving portion of the salad making device. When the wrappers and salad materials are compacted, the wrappers will surround the compacted salad materials. In some embodiments, the wrappers merge together to form a single wrapper (for example, the wrappers become slightly wet from the salad materials, and when wet the wrappers are adhesive, so when they are compacted together, they will adhere to each other forming a single wrapper). In some embodiments, the first wrapper and second wrapper are different flavors such as complementary flavors (e.g., peanut butter and jelly). In some embodiments, the first wrapper contains half of the ingredients/flavors and the second wrapper contains the other half of ingredients/flavors, and when the wrappers are combined a full flavor wrapper is generated. In some embodiments, the first wrapper goes into a first opening, and the second wrapper goes into a second opening.

In some embodiments, the wrapper is placed at one end or another of where the salad materials are compacted. The wrapper is able to be placed on top of or on the bottom of the salad materials.

In some embodiments, the salad dressing or other flavoring is implemented in strips, balls, chunks, chips, shredded pieces or any other form to be placed with the salad materials to be compacted. For example, by including salad dressing balls (e.g., flavored rice combination shaped like balls) in the salad materials, the salad dressing flavor is able to be distributed throughout the compact salad instead of just on the outside. In another example, by using strips or another structure, the user simply adds the salad dressing strips to the salad materials and the salad dressing strips adhere to each other when they come in contact and form a structure that holds the salad together. In some embodiments, one or more wrappers and the embedded flavorings (e.g., balls, strips) are utilized together.

In some embodiments, there are components/features to add additional salad materials such as meats, croutons, cheese such that the salad materials are distributed relatively evenly. For example, as described herein, in some embodiments, a mixing implementation is utilized. In another example, a crouton maker is included which stores the bread and chops the bread into croutons. In yet another example, a cheese holding component shreds the cheese on the salad.

In some embodiments, the salad making device is able to be used to make other items besides salad, such as compacting a hot wing chicken pieces and ranch dressing wrapped in a wrapper (or the chicken pieces are wrapped in a ranch dressing-flavored wrapper). In another example, celery and peanut butter (or a peanut butter flavored wrapper) are combined and compacted. For example, chopped celery and peanut butter are compacted in a wrapper, or a chopped celery is wrapped up in a peanut butter-flavored wrapper. As described herein, the salad making device is not limited to making salads.

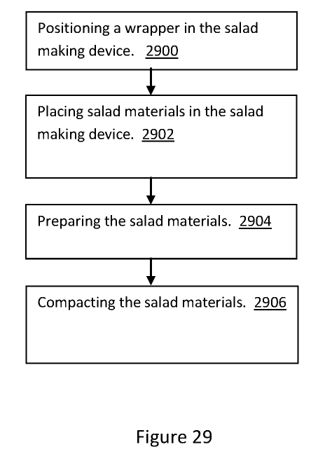

FIG. 29 illustrates a flowchart of a salad compacting method according to some embodiments. In the step 2900, a wrapper is positioned appropriately in the salad making device. Depending on the implementation, the wrapper may be placed near an exit aperture, in a salad wrapper holder, in a receiving portion, and/or anywhere else appropriate for receiving salad materials. In the step 2902, salad materials are placed in the salad making device. Depending on the implementation, the salad materials may be placed in an opening at the top of a salad making device, inserted into a receiving portion of a salad making device or placed in any other appropriate location. In the step 2904, the salad materials are prepared. For example, preparing includes mixing, washing, chopping, dressing, and/or any other preparation. In the step 2906, the salad materials are compacted. As described herein, the salad materials are able to be compacted using any structural configuration as well as either manually or automatically. In some embodiments, compacting the salad materials includes compacting the salad materials within the wrapper. In some embodiments, the order of the steps is modified. In some embodiments, fewer or additional steps are implemented. For example, when a wrapper is not used, the step 2900 is able to be skipped, or if no preparation is desired, the step 2904 is skipped.

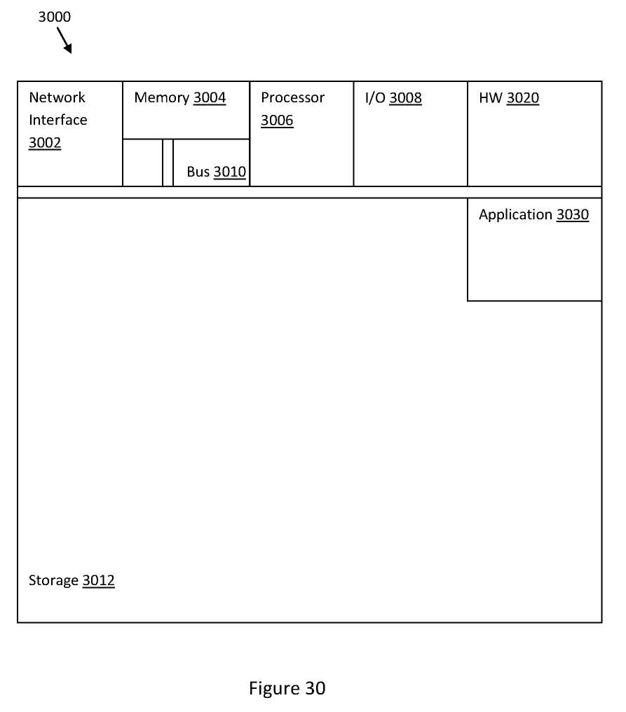

FIG. 30 illustrates a block diagram of an exemplary computing device 3000 configured to implement the salad making method according to some embodiments. The computing device 3000 is able to be used to acquire, store, compute, process, communicate and/or display information including, but not limited to, text, images, videos and audio. In some examples, the computing device 3000 is able to be used to monitor information, process the information, and/or provide a status of the information. Furthering the examples, the computing device 3000 receives commands from a user's smart phone such as wash, dressing, compact, including how much to compact the salad, when to prepare the salad, and/or any other data. In general, a hardware structure suitable for implementing the computing device 3000 includes a network interface 3002, a memory 3004, a processor 3006, I/O device(s) 3008, a bus 3010 and a storage device 3012. The choice of processor is not critical as long as a suitable processor with sufficient speed is chosen. The memory 3004 is able to be any conventional computer memory known in the art. The storage device 3012 is able to include a hard drive, CDROM, CDRW, DVD,

DVDRW, flash memory card, solid state drive or any other storage device. The computing device 3000 is able to include one or more network interfaces 3002. An example of a network interface includes a network card connected to an Ethernet or other type of LAN. The I/O device(s) 3008 are able to include one or more of the following: keyboard, mouse, monitor, display, printer, modem, touchscreen, touchpad, speaker/microphone, voice input device, button interface, hand-waving, body-motion capture, touchless 3D input, joystick, remote control, brain-computer interface/direct neural interface/brain-machine interface, camera, and other devices. In some embodiments, the hardware structure includes multiple processors and other hardware to perform parallel processing. Salad making application(s) 3030 used to perform the monitoring, processing, and providing are likely to be stored in the storage device 3012 and memory 3004 and processed as applications are typically processed. More or fewer components shown in FIG. 30 are able to be included in the computing device 3000. In some embodiments, salad making hardware 3020 is included. Although the computing device 3000 in FIG. 30 includes applications 3030 and hardware 3020 for implementing the salad making, the salad making method is able to be implemented on a computing device in hardware, firmware, software or any combination thereof. For example, in some embodiments, the salad making applications 3030 are programmed in a memory and executed using a processor. In another example, in some embodiments, the salad making hardware 3020 is programmed hardware logic including gates specifically designed to implement the method.

In some embodiments, the salad making application(s) 3030 include several applications and/or modules. Modules include a monitoring module for monitoring information, a processing module for processing (e.g., converting) information, a salad making module for making/compacting a salad (e.g., the module triggers the walls to move to compact the salad materials), and a providing module for providing a status of the information. In some embodiments, modules include one or more sub-modules as well. In some embodiments, fewer or additional modules are able to be included.

Examples of suitable computing devices include, but are not limited to a personal computer, a laptop computer, a computer workstation, a server, a mainframe computer, a handheld computer, a personal digital assistant, a pager, a telephone, a fax machine, a cellular/mobile telephone, a smart appliance, a gaming console, a digital camera, a digital camcorder, a camera phone, a smart phone/device (e.g., a Droid® or an iPhone®), a portable music player (e.g., an iPod®), a tablet (e.g., an iPad®), a video player, an e-reader (e.g., Kindle™), a DVD writer/player, an HD (e.g., Blu-ray®) or ultra high density writer/player, a television, a copy machine, a scanner, a car stereo, a stereo, a satellite, a DVR (e.g., TiVo®), a smart watch/jewelry, smart devices, a home entertainment system or any other suitable computing device.

Typically, the computing device is included in/with a stand alone salad making device as shown in the Figures. For example, a salad making device includes a memory, processor and any other computing components to perform computing processes, in addition to the compacting mechanisms such as walls that move to compact, tubes that narrow and/or any other salad making mechanisms. Any computing device combination/implementation is possible.

The computing device enables a user to control the salad making device using a smart device (e.g., smart phone) or another interface (e.g., front panel of the salad making device). The computing device is also able to include sensors for providing information to the user and/or to be used to perform automatically. For example, a sensor informs the user how compacted the salad is, and the user can increase the compaction or stop. In another example, the user is able to pre-program how compacted he wants his salad (e.g., 50% of original size), and when the sensor detects 50% compaction, the compactor stops. Any sensor for detecting pressure is able to be implemented such as a piezoelectric sensor. In another example, a water sensor is implemented to determine how wet the salad is, and inform the user or stop compacting when the salad has lost a certain amount of water (e.g., 1 teaspoon). The computing device enables a user to set a timer (e.g., make a salad at 5 pm using pre-loaded salad materials).

In some embodiments, the salad making device includes a refrigeration unit/mechanism to keep the salad materials and/or the compacted salad chilled. The refrigeration is able to be implemented in any manner (e.g., an ice reservoir, a motorized coolant system, an air tight seal to maintain temperature).

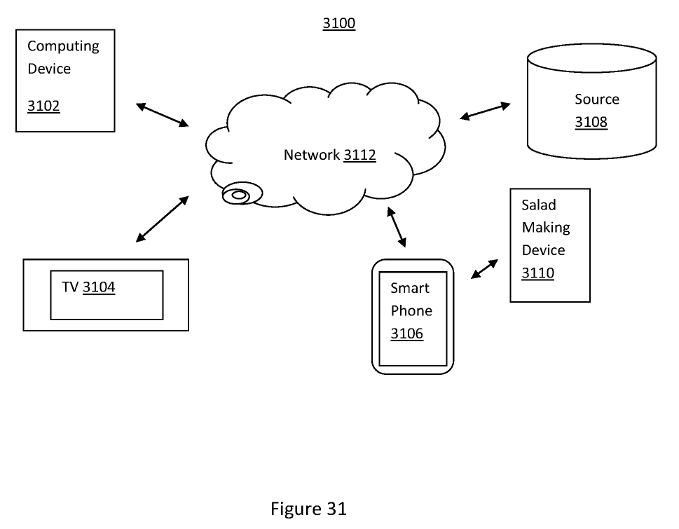

FIG. 31 illustrates a network of devices configured to implement salad making according to some embodiments. The network of devices 3100 is able to include any number of devices and any various devices including, but not limited to, a computing device (e.g., a tablet) 3102, a television 3104, a smart device 3106 (e.g., a smart phone), a source 3108 (e.g., a database), and a salad making device 3110 coupled through a network 3112 (e.g., the Internet). The source device 3108 is able to be any device containing source information including, but not limited to, a searchable database (e.g., recipes, order information, instructional guides), web pages, statistics (e.g., usage information), historical information, or any other information or device that provides information. By using the source information from the source device 3108, steps are able to be automated such as recognizing that a user always eats an Italian dressing compacted salad at 5 pm, so the salad making device 3110 is able to automatically make that specific salad at that specific time without the user having to specify. The source information or other information is also able to be used to notify the user to purchase additional products (e.g., there are only 2 wrappers left, purchase more) or automatically purchase more when a threshold is detected. The network 3112 is able to be used to perform any networked tasks such as sharing information, receiving information, automatically starting/ending processes and/or any other tasks. The network 3112 is able to any network or networks including, but not limited to, the Internet, an intranet, a LAN/WAN/MAN, wireless, wired, Ethernet, satellite, cellular network, a combination of networks, or any other implementation of communicating. The devices are able to communicate with each other through the network 3112 and/or directly to each other. In some embodiments, the devices communicate using Near Field Communication (NFC) or a similar implementation. One or more of the devices is able to be an end user device, a company and/or another entity.

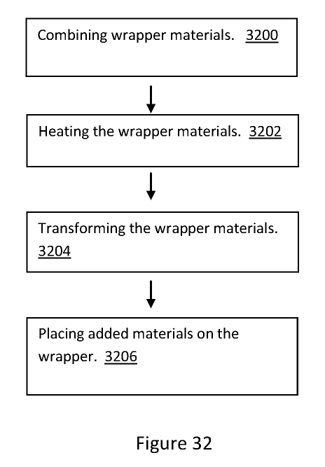

FIG. 32 illustrates a flowchart of a method of generating a wrapper according to some embodiments. In the step 3200, wrapper materials are combined (e.g., water and starch, or salad dressing materials and starch). In some embodiments, a flavoring is added to the wrapper materials as well (e.g., ranch, Italian, French, vinaigrette, Caesar, or any other salad dressing). In the step 3202, the wrapper materials are heated (e.g., using a dehydrator, solar or an oven) to generate wrapper. For example, when the materials dry or cook, they form a wrapper. In some embodiments, the generated wrapper is 2D or 3D. In some embodiments, the wrapper materials are placed in a 3D mold and heated. In some embodiments, the wrapper materials are placed in a shaped holder while they dry/cook to generate a specific shaped wrapper. In some embodiments, the wrapper materials are cooled (e.g., using a freezer or liquid nitrogen spray) to generate the wrapper. In some embodiments, the wrapper materials are not heated or cooled and just utilize time to generate the wrapper. In the step 3204, the wrapper materials are placed in a mold to transform the wrapper into a 3D wrapper. For example, a large square wrapper is placed in a 3-D square mold to generate a roughly cube shape with an open side. In the step 3206, added materials are placed on the wrapper. For example, the one or more sides of the wrapper is coated with oil, flavoring (e.g., salad dressing), seeds, salt, coloring and/or anything else. In some embodiments, the order of the steps is modified, for example, the mixture is placed in a mold before the mixture is heated/cooled/left to form a wrapper. In some embodiments, one or more of the steps are combined. For example, the coloring is able to be combined with the step of combining the wrapper materials. In some embodiments, fewer or additional steps are implemented. For example, instead of first forming a roughly 2D wrapper, that step is skipped, and the wrapper materials are placed in a 3D mold, and then the materials are heated forming a 3D wrapper.

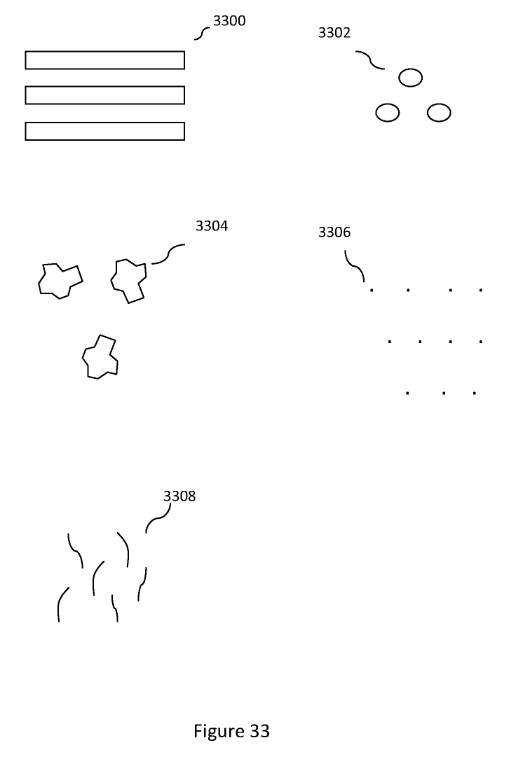

FIG. 33 illustrates diagrams of salad dressing strips, balls, chunks, crystals, and shreds according to some embodiments. The different salad dressing forms are able to be generated in any manner and are able to include any materials such as starch and salad dressing flavoring or any materials described herein related to the wrapper. For example, a salad dressing flavoring is combined with a starch such as tapioca starch or rice starch, and the combination is heated (e.g., baked) to form sheets of the salad dressing flavored material, and then the material is able to be manipulated (e.g., cut, rolled or broken) into various configurations (e.g., strips, balls, chunks, crystals, shreds). In some embodiments, the salad dressing materials are configured so that when they get wet they adhere to each other and/or other items to provide structure. Although strips 3300, balls 3302, chunks 3304, crystals 3306, and shreds 3308 are described herein, any shape/structure is possible.

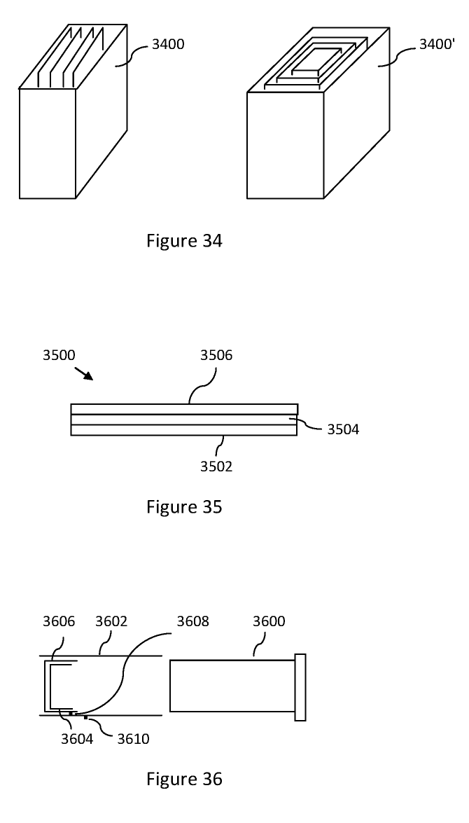

FIG. 34 illustrates a diagram of a salad dressing material portable container according to some embodiments. The container 3400 enables a user to carry the salad dressing wrappers, strips and/or other shapes conveniently. In some embodiments, the salad dressing wrappers are separated by a material such as wax paper to keep them separate. In some embodiments, the salad dressing container 3400 includes partitions to keep the wrappers separate. In some embodiments, the wrappers are nested within each other in the salad dressing container 3400′. The container 3400 is able to be made of any appropriate material such as metal, plastic, silicone, wood, glass, and/or any combination thereof. In some embodiments, the container 3400 includes a top in order to close the container 3400.

FIG. 35 illustrates a diagram of a wrapper with multiple layers according to some embodiments. The wrapper 3500 is able to have any number of layers such as a structural layer 3502 (e.g., a starch), a flavoring layer 3504 (e.g., salad dressing flavoring) and a coating layer 3506 (e.g., oil). In some embodiments, the wrapper 3500 includes an inedible layer.

FIG. 36 illustrates a view of a handheld salad making device with a wrapper holder and a wrapper according to some embodiments. The handheld salad making device includes a plunger portion 3600 or insertable portion (e.g., a solid tube with a cap) and a receiving portion 3602 (e.g., a hollow tube). In some embodiments, the hollow tube has a bottom cap/end which is able to be locked (while the salad materials are being compacted) and opened (for removal of the compacted salad). The wrapper 3604 is able to be made of any materials as described herein such as solidified salad dressing. The wrapper 3604 (e.g., a cube with an open side or a 5 sided cube) is inserted into a wrapper holder 3606 which is inserted into the receiving portion 3602, and then salad materials are inserted into the receiving portion 3602. Then, the plunger portion 3600 is inserted into the receiving portion 3602 which compacts the salad materials into the wrapper 3604. In some embodiments, the bottom, top and/or sides of the receiving portion 3602 are unlocked and opened, and then the wrapper holder 3606 containing the wrapper 3604 containing the compacted salad is removed. In some embodiments, the wrapper holder 3606 is shaped similar to a wrapper but is inedible. For example, the wrapper holder 3606 is placed in the receiving portion 3602, locks into place in the receiving portion 3602 using a locking mechanism 3608, the salad materials are compacted into a wrapper in the receiving portion 3602, then the wrapper holder 3606 is unlocked using a button 3610 and the compacted salad is removed from the receiving portion 3602. The locking mechanism 3608 and button 3610 are able to operate together in any manner such as a spring locking system or a simple lever system which when the button 3610 is pushed, the locking mechanism 3608 releases its pressure/friction grip of the wrapper holder 3606 or moves from away from the lip of the wrapper holder 3606 or moves out of a slit in the wrapper holder 3606.

In an exemplary salad making device, the salad making device includes at least one tube to receive a wrapper and salad materials, and at least one plunger for compacting the salad materials in the wrapper. The wrapper includes a flavoring such as salad dressing. The flavoring is able to be sprayed on the wrapper, mixed into the wrapper, applied on as strips of flavoring or swirls of flavoring, or placed on the wrapper as bumps or dots. The flavoring is able to be evenly distributed or distributed as a gradient of flavoring (e.g., one end of the wrapper has little flavoring and the amount of flavoring increases gradually to the other end which has the most flavoring). For 3D wrappers, the gradient of flavoring is able to be applied by flavoring one part of the wrapper more than an opposite part and gradually increasing flavoring between the two. In some embodiments, for 3D wrappers, only one side is flavored. Coloring is able to be used to indicate the amount of flavoring (e.g., the coloring gradually becomes darker as the amount of flavoring increases). In some embodiments, the wrapper has multiple layers (a structural layer, a flavor layer, a coloring layer, and a coating/oil layer). An exemplary structural layer includes: a stiff layer, a bonding layer, a binding layer, and/or a starch layer. In some embodiments, two or more of the multiple layers mix when they become wet. In some embodiments, the wrapper is able to receive one or more flavors or layers. For example, the wrapper includes a base layer (e.g., starch layer), and a user is able to place one or more layers (e.g., flavors) on the base layer. The flavor layer is able to be a thin strip of dried salad dressing or salad dressing mixed with a starch to provide additional structure. In some embodiments, the wrapper includes pockets for receiving the flavoring and/or another layer/coating. The wrapper is foldable in any manner In some embodiments, the wrapper has holes and/or a web-like structure to reduce the amount of material used to secure the salad materials. In some embodiments, an inedible portion of the wrapper has holes and/or has a web-like structure. In some embodiments, the wrapper includes multiple flavors. For example, a left half of a wrapper includes a first flavor, and a right half of the wrapper includes a second flavor. In some embodiments, both sides of a wrapper are coated, the wrapper is coated on just the tips and/or edges, or the edges and/or tips are uncoated (e.g., a protective cover is placed on the edge/tips which is then pulled off after coating is applied). In some embodiments, when the wrapper is wet, it dissolves slightly but maintains the structure slightly. In some embodiments, the coloring of the wrapper is in the form of strips, spots, swirls and/or any other design. In some embodiments, the coloring includes sprinkles in the salad materials which mix with the salad water and color the wrapper by dripping on the wrapper and staining the wrapper.

Although some implementations and/or embodiments have been described related to specific implementations and/or embodiments, and some aspects/elements/steps of some implementations and/or embodiments have been described related to specific implementations and/or embodiments, any of the aspects/elements/steps, implementations and/or embodiments are applicable to other aspects/elements/steps, implementations and/or embodiments described herein.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A system configured for compacting salad materials into a compact salad comprising:
a wrapper;
a first tube configured for receiving the wrapper and salad materials; and
a first plunger configured for fitting within the first tube for compacting the salad materials in the wrapper in the first tube.

2. The system of claim 1 wherein the wrapper includes a salad dressing flavoring, wherein the salad dressing flavoring is applied in a gradient-manner with a first end of the wrapper having less salad dressing flavoring than a second end of the wrapper, and a continuously increasing amount of the salad dressing flavoring from the first end of the wrapper to the second end of the wrapper.

3. The system of claim 2 wherein the wrapper comprises an added coloring which matches an amount of the salad dressing flavoring, including a gradient of coloring, wherein the first end of the wrapper has less coloring than the second end of the wrapper.

4. The system of claim 1 wherein the wrapper comprises raised dots of flavoring on a first side of the wrapper.

5. The system of claim 1 wherein the wrapper comprises multiple layers, wherein the multiple layers mix when wet, further wherein the wrapper is configured to receive one or more additional layers by a user.

6. The system of claim 1 wherein the wrapper comprises a three dimensional shape with an opening.

7. The system of claim 6 wherein the wrapper is generated by heating wrapper materials in a three dimensional shape mold.

8. The system of claim 1 wherein a first side of the wrapper is sticky, and a second side of the wrapper is non-sticky, and wherein the wrapper comprises dissolvable materials.

9. The system of claim 1 wherein the first tube comprises a narrowing end, and the first plunger comprises a narrowing end, further wherein the salad materials are compacted in the wrapper when the first plunger is pushed in the first tube.

10. The system of claim 1 wherein the wrapper comprises a cone shape, wherein an open end of the wrapper is approximately 10% larger than an opening of the first tube.

11. The system of claim 1 further comprising a secondary wrapper configured for merging with the wrapper into a single wrapper to secure the salad materials within the single wrapper.

12. The system of claim 1 wherein the first tube is further configured for receiving additional salad dressing flavorings implemented in a form of strips, chunks, crystals, or shredded pieces.

13. The system of claim 1 further comprising:
a motor configured for moving the first plunger in the first tube for compacting the salad materials into the wrapper; and
a computing device configured for receiving input related to the salad materials and controlling the motor based on the input, wherein the input includes a percent related to how much the salad materials are to be compacted.

14. The system of claim 13 wherein the input is received from a smart phone.

15. The system of claim 1 further comprising at least a second tube and a second plunger for compacting the salad materials in the wrapper.

16. The system of claim 1 further comprising a sensor configured for determining when to stop compacting the salad materials.

17. The system of claim 1 further comprising a holding component configured for receiving and securing the wrapper while the salad materials are compacted into the wrapper.

18. The system of claim 1 further comprising a plurality of movable walls, floors and ceilings configured for compacting the salad materials.

19. A wrapper comprising:
a starch component; and
a salad dressing component, wherein the wrapper is configured to be received by a salad making device to compact salad materials into the wrapper to form a compacted salad.

20. A method comprising:
mixing a starch with salad dressing materials to generate a mixture;
placing the mixture in a three dimensional mold;
placing the three dimensional mold in a heating device; and
heating the mixture in the heating device until the mixture solidifies to generate a wrapper;
placing the wrapper in a salad making device to compact salad materials into the wrapper to form a compacted salad.
